(19) United States
(12) Patent Application Publication
(10) Pub. No.: US 2019/0331503 A1
(43) Pub. Date: Oct. 31, 2019

(54) INFORMATION PROCESSING DEVICES AND INFORMATION PROCESSING METHOD

(71) Applicant: Panasonic Intellectual Property Corporation of America, Torrance, CA (US)

(72) Inventors: Takahiro YONEDA, Osaka (JP); Shuhei MATSUI, Osaka (JP)

(21) Appl. No.: 16/390,578

(22) Filed: Apr. 22, 2019

(30) Foreign Application Priority Data
Apr. 27, 2018 (JP) 2018-086471
Dec. 17, 2018 (JP) 2018-235217

(51) Int. Cl. G01C 21/34; H04W 4/40; G01C 21/36

(52) U.S. Cl. CPC G01C 21/3492; G01C 21/3415; G01C 21/3632; H04W 4/40

(57) ABSTRACT

Provided is an information processing device included in a vehicle terminal in a vehicle. The information processing device is configured to: obtain vehicle position information indicating a position of the vehicle terminal; transmit, at each of a plurality of positions of the vehicle terminal, a signal to be received directly by a passenger terminal of a passenger who intends to get on the vehicle; transmit, to a server, a plurality of pieces of specific vehicle position information each indicating one of the plurality of positions of the vehicle terminal; and receive, from the server, corrected passenger position information indicating a corrected position of the passenger terminal after the signal is transmitted at each of the plurality of positions of the vehicle terminal.

### CROSS REFERENCE TO RELATED APPLICATIONS

This application claims the benefit of priority of Japanese Patent Application Number 2018-086471 filed on Apr. 27, 2018 and Japanese Patent Application Number 2018-235217 filed on Dec. 17, 2018, the entire contents of which are hereby incorporated by reference.

### BACKGROUND

### 1. Technical Field

The present disclosure relates to information processing devices and an information processing method.

### 2. Description of the Related Art

In recent years, as a method for estimating the position of an object, a method using a satellite positioning system such as GPS (global positioning system) is known (see Japanese Patent No. 5866877, for example).

Japanese Patent No. 5866877 discloses a technique of obtaining, via near-field communication, GPS-based position information from a terminal device whose GPS radio field intensity is higher than a threshold, and when three or more pieces of position information are obtained, estimating the position of the terminal device based on the three or more pieces of position information and the radio field intensity in the near-field communication.

Meanwhile, there are services that present a meeting place for a pick-up vehicle and a passenger to meet one another, using GPS-based position information.

### SUMMARY

However, conventional techniques such as the one disclosed in Japanese Patent No. 5866877 require two or more devices that provide position information. For example, in Japanese Patent No. 5866877, estimation of the position of the terminal device requires a plurality of other terminal devices.

In view of this, the present disclosure provides information processing devices and an information processing method capable of improving the accuracy or precision of the position of a passenger terminal even when the number of in-vehicle terminals that provide position information is one.

In order to provide such information processing devices and an information processing method as described above, an information processing device according to an aspect of the present disclosure is an information processing device included in a vehicle terminal in a vehicle. The information processing device is configured to: obtain vehicle position information indicating a position of the vehicle terminal; transmit, at each of a plurality of positions of the vehicle terminal, a signal to be received directly by a passenger terminal of a passenger who intends to get on the vehicle; transmit, to a server, a plurality of pieces of specific vehicle position information each indicating one of the plurality of positions of the vehicle terminal; and receive, from the server, corrected passenger position information indicating a corrected position of the passenger terminal after the signal is transmitted at each of the plurality of positions of the vehicle terminal.

Note that the above general or specific aspects may be realized by a system, a method, an integrated circuit, a computer program, or a computer-readable recording medium such as a CD-ROM (compact disc read only memory), or by any combination of systems, methods, integrated circuits, computer programs, or recording media.

Information processing devices and an information processing method according to the present disclosure are capable of improving the accuracy or precision of the position of a passenger terminal even when the number of in-vehicle terminals that provide position information is one.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a schematic diagram illustrating a configuration of a navigation system according to Embodiment 1;

FIG. 2 is a block diagram illustrating a configuration of a passenger terminal according to Embodiment 1;

FIG. 3 is a block diagram illustrating a configuration of a vehicle terminal according to Embodiment 1;

FIG. 4 is a block diagram illustrating a configuration of a server according to Embodiment 1;

FIG. 5 is a sequence diagram illustrating operations of the navigation system according to Embodiment 1;

FIG. 6 is a schematic diagram illustrating transmission of a beacon signal and beacon information, performed when the passenger terminal and the vehicle terminal according to Embodiment 1 are in a given positional relationship;

FIG. 7 is a schematic diagram illustrating how the position of the passenger terminal is estimated in the case where the vehicle terminal according to Embodiment 1 transmits signals at different positions;

FIG. 8 is a schematic diagram illustrating an example case of continuously updating a corrected position of the passenger terminal in the case where the passenger according to Embodiment 1 is travelling toward the vehicle;

FIG. 9 is a schematic diagram illustrating passenger guidance information displayed on the passenger terminal according to Embodiment 1;

FIG. 10 is a schematic diagram illustrating vehicle guidance information displayed on the vehicle terminal according to Embodiment 1;

FIG. 11 is a flow chart illustrating operations of the vehicle terminal according to Embodiment 1;

FIG. 12 is a flow chart illustrating operations of the passenger terminal according to Embodiment 1;

FIG. 13 is a flow chart illustrating operations of the server according to Embodiment 1; and

FIG. 14 is a flow chart illustrating operations of a vehicle terminal according to Embodiment 2.

### DETAILED DESCRIPTION OF THE EMBODIMENTS

(Developments that Resulted in the Present Disclosure)

Recent years have seen services that present a meeting place for a pick-up vehicle and a passenger to meet one another, using GPS-based position information. With the GPS, however, the precision of determining the position of a terminal may decrease in environments such as indoors, in the city, or a mountainous region where radio waves from a plurality of satellites cannot be adequately received.

A method that allows a terminal to estimate its own position using base stations of a cellular system is also known. In this method, the terminal calculates the distances between the base stations and the terminal using position information of the base stations and the radio field intensities of signals transmitted from the base stations. The terminal estimates its own position using a trilateration method based on the distances between the plural base stations and the terminal and the position information of each base station.

In addition, as a method of estimating its own position indoors, a method of using a beacon signal via near-field communication is also known. In this method, assuming that the positions of beacon transmitters that transmit a beacon signal remain unchanged, the accurate position of each beacon transmitter can be estimated using the beacon transmitters and a beacon receiver which receives beacon signals.

Specifically, when the beacon receiver receives a beacon signal transmitted from a beacon transmitter, the beacon receiver calculates the distance between the beacon transmitter and the beacon receiver based on the radio field intensity of the beacon signal received. The beacon receiver estimates the position of the beacon receiver using a trilateration method based on the distances between the beacon receiver and plural beacon transmitters and the position of each beacon transmitter. With this position estimation method using a beacon signal via near-field communication, high positioning accuracy can be achieved as long as the beacon signal can reach the beacon receiver.

With such methods using base stations of a cellular system or beacon transmitters, however, three or more base stations or beacon transmitters need to be installed in advance in the area where position estimation is desired. In other words, the area in which the estimation of the beacon receiver position is possible is limited to areas where three or more beacon transmitters can be installed.

In view of the above, an information processing device according to an aspect of the present disclosure is an information processing device included in a vehicle terminal in a vehicle. The information processing device is configured to: obtain vehicle position information indicating a position of the vehicle terminal; transmit, at each of a plurality of positions of the vehicle terminal, a signal to be received directly by a passenger terminal of a passenger who intends to get on the vehicle; transmit, to a server, a plurality of pieces of specific vehicle position information each indicating one of the plurality of positions of the vehicle terminal; and receive, from the server, corrected passenger position information indicating a corrected position of the passenger terminal after the signal is transmitted at each of the plurality of positions of the vehicle terminal.

In such a manner, the vehicle terminal can obtain the vehicle position information indicating its own position and the corrected passenger position information indicating the corrected position of the passenger terminal. Since the vehicle terminal transmits the vehicle position information indicating its own position to the passenger terminal as well, it is possible to allow the passenger terminal to obtain, via the server, the vehicle position information regarding a plurality of positions of the vehicle terminal. With this, the passenger terminal can generate corrected passenger position information indicating a position more accurate than the position indicated by the passenger position information.

Accordingly, the information processing device can increase the accuracy or precision of the passenger terminal position even when the number of in-vehicle terminals that provide position information is one. The information processing device enables the passenger to smoothly get on a pick-up vehicle at a meeting place.

The information processing device according to an aspect of the present disclosure is further configured to determine whether the vehicle terminal and the passenger terminal are in a predetermined positional relationship, using the vehicle position information and passenger position information indicating a position of the passenger terminal. The information processing device is configured to start transmitting the signal when the determination unit determines that the vehicle terminal and the passenger terminal are in the predetermined positional relationship.

In such a manner, when the vehicle terminal and the passenger terminal are determined to be in a predetermined positional relationship, the information processing device can cause the passenger terminal to receive the signal transmitted by the information processing device.

In particular, the information processing device can allow the passenger terminal to estimate the position of the passenger terminal by measuring the radio field intensity, which is the reception signal intensity, of each signal received (hereinafter, referred to as the radio field intensity of a signal), for example.

In the information processing device according to an aspect of the present disclosure, the signal includes signal identification information for identifying the signal.

Since each signal includes signal identification information as stated above, the passenger terminal can identify each signal. As a result, the information processing device can allow the passenger terminal to obtain each piece of vehicle position information transmitted by the vehicle terminal.

The information processing device according to an aspect of the present disclosure is further configured to obtain, from the vehicle terminal, traveling information regarding traveling of the vehicle, and control transmission intervals of the signal based on the traveling information.

For example, when the vehicle terminal is not travelling, that is, when transmission of signals is not likely to be helpful in correcting the passenger position information, the communication processor increases the signal transmission intervals. This enables power savings and effective use of communication bands in the vehicle terminal. Conversely, when the vehicle terminal is travelling at high speed, the communication processor shortens the signal transmission intervals. This makes it possible to cover failure of signal reception by the passenger terminal.

In particular, by controlling the signal transmission intervals, the information processing device can transmit a signal at a position and then transmit a signal again at a position a predetermined distance away from the previous position. In such a case, since the signals are transmitted at positions distant from each other, the information processing device can allow the passenger terminal to more accurately estimate the position of the passenger terminal.

In the information processing device according to an aspect of the present disclosure, the traveling information indicates a traveling speed of the vehicle terminal or a change in the position of the vehicle terminal, and the information processing device is configured to shorten the transmission intervals as the traveling speed increases or as the change in the position of the vehicle terminal increases.

In such a manner, the communication processor shortens the transmission intervals of signals transmitted by the first communication unit as the traveling speed of the vehicle terminal in a first time period becomes faster than the traveling speed of the vehicle terminal in a second time period or as the distance between a position of the vehicle terminal at a first time point and a position of the vehicle terminal at a second time point increases, for example. This allows the information processing device to transmit a plurality of signals to the passenger terminal within a short time period. Accordingly, for example, even when the passenger terminal has failed to receive a signal, as long as the passenger terminal can receive another signal transmitted within a short transmission interval, it is possible to reduce the risk of the passenger terminal failing to receive all the signals used for correcting the passenger terminal position.

In particular, since the information processing device transmits a plurality of signals to the passenger terminal within a short time period, the passenger terminal can measure its own position within a shorter time period.

The information processing device according to an aspect of the present disclosure further configured to: control presentation of navigation information for the vehicle terminal; and receive the navigation information from the server. The navigation information includes information indicating navigation based on the vehicle position information and the corrected passenger position information. The information processing device is configured to change a presentation mode of the navigation information according to a change in the corrected passenger position information.

As described above, when the corrected passenger position information is obtained, the second communication unit receives, from the server, navigation information including the vehicle position information and the corrected passenger position information. Accordingly, the presentation controller can obtain the navigation information indicating an accurate position of the passenger terminal according to a change in the corrected passenger position information. With this, for example, the presentation controller can present to the vehicle terminal the navigation information indicating an accurate position of the passenger terminal according to the positional relationship between the vehicle terminal and the passenger terminal, by performing presentation control such as increasing the display size of the content of the navigation information as the distance between the vehicle terminal and the passenger terminal decreases.

The information processing method according to an aspect of the present disclosure further includes generating navigation information for the vehicle terminal or the passenger terminal using the vehicle position information and the corrected passenger position information, and transmitting the navigation information to the vehicle terminal or the passenger terminal.

As can be seen from above, the information processing method yields the same advantageous effect as described earlier.

In the information processing device according to an aspect of the present disclosure, the navigation information indicates at least one of a distance and a route from the position of the vehicle terminal to the corrected position of the passenger terminal indicated by the corrected passenger position information.

As stated above, the presentation controller can present to the vehicle terminal, for example, the navigation information indicating at least one of a distance and a route from the position of the vehicle terminal to the corrected position of the passenger terminal.

In the information processing device according to an aspect of the present disclosure, the signal is a beacon signal.

When the signal is a beacon signal as stated above, it is possible to increase the accuracy of the estimation of the passenger terminal position while using the existing unidirectional communication technology.

An information processing device according to an aspect of the present disclosure is an information processing device included in a passenger terminal of a passenger who intends to get on a vehicle. The information processing device is configured to: obtain passenger position information indicating a position of the passenger terminal; directly receive a signal transmitted from a vehicle terminal at each of a plurality of positions of the vehicle terminal, and measure a radio field intensity of the signal, the vehicle terminal being included in the vehicle; generate corrected passenger position information indicating a corrected position of the passenger terminal, using the passenger position information and a plurality of pairs each including (i) information indicating the radio field intensity of the signal transmitted at one of the plurality of positions of the vehicle terminal and (ii) one of a plurality of pieces of specific vehicle position information that indicates the one of the plurality of positions of the vehicle terminal; and receive the plurality of pieces of specific vehicle position information from a server, and transmit the corrected passenger position information to the server.

In such a manner, the passenger terminal can obtain the passenger position information indicating its own position and the vehicle position information indicating the position of the vehicle terminal. This enables the passenger terminal to generate the corrected passenger position information indicating a corrected position of the passenger terminal.

Accordingly, the information processing device can increase the accuracy or precision of the passenger terminal position even when the number of in-vehicle terminals that provide position information is one.

The information processing device according to an aspect of the present disclosure is further configured to: receive vehicle position information indicating a position of the vehicle terminal; determine whether the vehicle terminal and the passenger terminal are in a predetermined positional relationship, using the vehicle position information and the passenger position information; and start being on standby to receive the signal from the vehicle terminal when it is determined that the vehicle terminal and the passenger terminal are in the predetermined positional relationship.

For example, if the passenger terminal is constantly in the standby state to receive a signal, its power consumption may become significant. It is thus necessary to inhibit an increase in the power consumption of the passenger terminal. In view of this, with the information processing device, determination that the passenger terminal and the vehicle terminal are in a predetermined positional relationship can be regarded as a trigger for the passenger terminal to start being on standby to receive a signal transmitted by the vehicle terminal. As a result, the information processing device can suppress the power consumption of the passenger terminal.

In the information processing device according to an aspect of the present disclosure, the signal includes signal identification information for identifying the signal. After receiving the signal transmitted at each of the plurality of positions of the vehicle terminal, the information processing device is configured to transmit the signal identification information of each signal and a request for the plurality of pieces of specific vehicle position information, and receive the plurality of pieces of specific vehicle position information as a response to the request.

In such a manner, by transmitting a request for a plurality of pieces of specific vehicle position information, the passenger terminal can receive a response to the request, that is, a plurality of pieces of specific vehicle position information associated with signal identification information. This enables the passenger terminal to generate corrected passenger position information indicating a corrected position of the passenger terminal based on the signal identification information and the plurality of pieces of specific vehicle position information.

The information processing method according to an aspect of the present disclosure further includes, after the signal transmitted at each of the plurality of positions of the vehicle terminal is received, receiving, from the passenger terminal, the plurality of pieces of signal identification information and a request for the plurality of pieces of specific vehicle position information, and transmitting the plurality of pieces of specific vehicle position information to the passenger terminal as a response to the request.

As can be seen from above, the information processing method yields the same advantageous effect as described earlier.

The information processing device according to an aspect of the present disclosure is further configured to: control presentation of navigation information for the passenger terminal; and receive the navigation information from the server. The navigation information includes information indicating navigation based on the vehicle position information and the corrected passenger position information.

As described above, when the corrected passenger position information is obtained, the second communication unit receives, from the server, navigation information including the vehicle position information and the corrected passenger position information. With this, for example, the presentation controller can present to the passenger terminal the navigation information indicating an accurate position of the passenger terminal according to the positional relationship between the passenger terminal and the vehicle terminal, by performing presentation control such as increasing the display size of the content of the navigation information as the distance between the passenger terminal and the vehicle terminal decreases.

In the information processing device according an aspect of the present disclosure, the signal is transmitted from a plurality of mutually different vehicle terminals or from the vehicle terminal that performs a plurality of signal transmissions, the plurality of mutually different vehicle terminals each being the vehicle terminal.

As described above, the passenger terminal can receive a plurality of different signals transmitted from one or more vehicle terminals. This enables the passenger terminal to, for example, measure the radio field intensity of each signal and, by positioning a plurality of points, calculate the distances between the one or more vehicle terminals and the passenger terminal based on each radio field intensity. By doing so, the passenger terminal can estimate its own position.

An information processing method according an aspect of the present disclosure is an information processing method including: receiving, from a vehicle terminal in a vehicle, vehicle position information indicating a position of the vehicle terminal; receiving, from a passenger terminal of a passenger who intends to get on the vehicle, passenger position information indicating a position of the passenger terminal; when the vehicle terminal and the passenger terminal are in a predetermined positional relationship, (i) receiving, from the vehicle terminal, (i-a) a plurality of pieces of signal identification information each for identifying a signal transmitted from the vehicle terminal at each of a plurality of positions of the vehicle terminal and (i-b) a plurality of pieces of specific vehicle position information each being the vehicle position information and indicating one of the plurality of positions of the vehicle terminal, and (ii) transmitting the plurality of pieces of signal identification information and the plurality of pieces of specific vehicle position information to the passenger terminal; and after transmitting the plurality of pieces of signal identification information and the plurality of pieces of specific vehicle position information to the passenger terminal, receiving, from the passenger terminal, corrected passenger position information indicating a corrected position of the passenger terminal, and transmitting the corrected passenger position information to the vehicle terminal.

With the information processing method described above, it is possible to obtain the vehicle position information indicating the position of the vehicle terminal and the passenger position information indicating the position of the passenger terminal. In the information processing method, the vehicle position information is transmitted to the passenger terminal and the passenger position information is transmitted to the vehicle terminal. With this, the information processing method enables the passenger terminal to generate corrected passenger position information indicating a corrected position of the passenger terminal.

Accordingly, it is possible to increase the accuracy or precision of the passenger terminal position even when the number of in-vehicle terminals that provide position information is one.

The information processing method according to an aspect of the present disclosure further includes, when the passenger position information is not obtained, generating the navigation information including information that guides the passenger to enable the passenger position information to be obtained.

As described above, by guiding the passenger to enable the passenger position information to be obtained, the passenger terminal position can be obtained more reliably.

The information processing method according to an aspect of the present disclosure further includes instructing the vehicle terminal to start transmitting the signal when the vehicle terminal and the passenger terminal are in a predetermined positional relationship.

Upon reception of such an instruction, the vehicle terminal can start transmitting the signal.

In particular, when the vehicle terminal and the passenger terminal are in a predetermined positional relationship, the passenger terminal may enter a standby status to receive a signal.

Note that the above general or specific aspects may be realized by a system, a method, an integrated circuit, a computer program, or a computer-readable recording medium such as a CD-ROM (compact disc read only memory), or by any combination of systems, methods, integrated circuits, computer programs, or recording media.

The following describes exemplary embodiments in detail with reference to the drawings. Note that each of the embodiments described below illustrates a specific example of the present disclosure. The numerical values, shapes, materials, structural elements, the arrangement and connection of the structural elements, steps, the processing order of the steps, etc. illustrated in the following embodiments are mere examples, and are not intended to limit the present disclosure. Furthermore, among the structural elements in the following embodiments, structural elements not recited in any one of the independent claims representing the most generic concepts are described as optional structural elements.

Note that the drawings are schematic illustrations and do not necessarily provide precise depictions. Moreover, throughout the figures, structural elements that are essentially the same share like reference signs, and overlapping descriptions thereof are omitted or simplified.

The following describes information processing devices and an information processing method according to embodiments of the present disclosure.

### Embodiment 1

### [Configuration]

First, the configuration of navigation system 1 according to the present embodiment will be described.

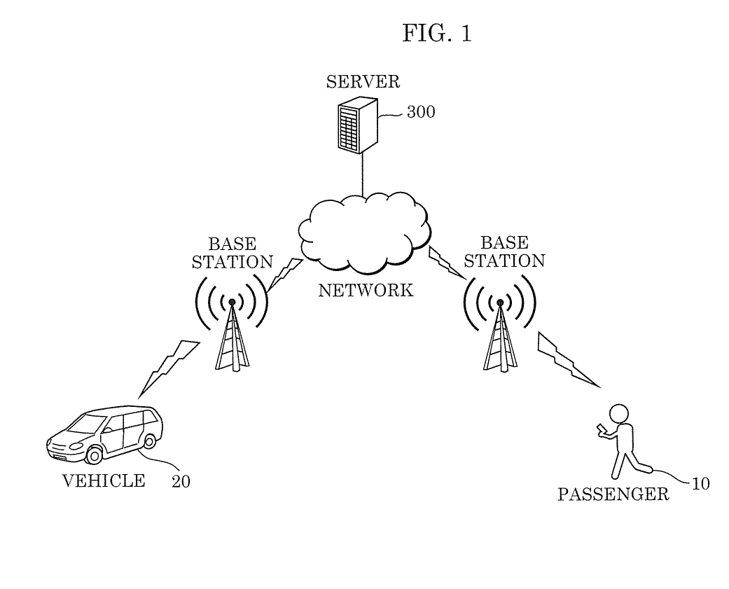

FIG. 1 is a schematic diagram illustrating the configuration of navigation system 1 according to Embodiment 1.

As illustrated in FIG. 1, navigation system 1 navigates vehicle 20 and passenger 10 who intends to get on vehicle 20, by allowing vehicle 20 and passenger 10 to share their respective positions. Navigation system 1 includes: passenger terminal 100 of passenger 10 who intends to get on vehicle 20; vehicle terminal 200 included in vehicle 20; and server 300. Note that passenger 10 refers not only to passenger 10 currently on vehicle 20 but also to passenger 10 who intends to get on vehicle 20. Moreover, passenger 10 refers not only to a person who pays for getting on vehicle 20 such as a taxi, but also to a person who gets on household vehicle 20 or the like without paying. Note that vehicle terminal 200 need not be built into vehicle 20, and may be simply placed in vehicle 20. For example, vehicle terminal 200 may be a terminal of the driver of vehicle 20.

### [Passenger Terminal]

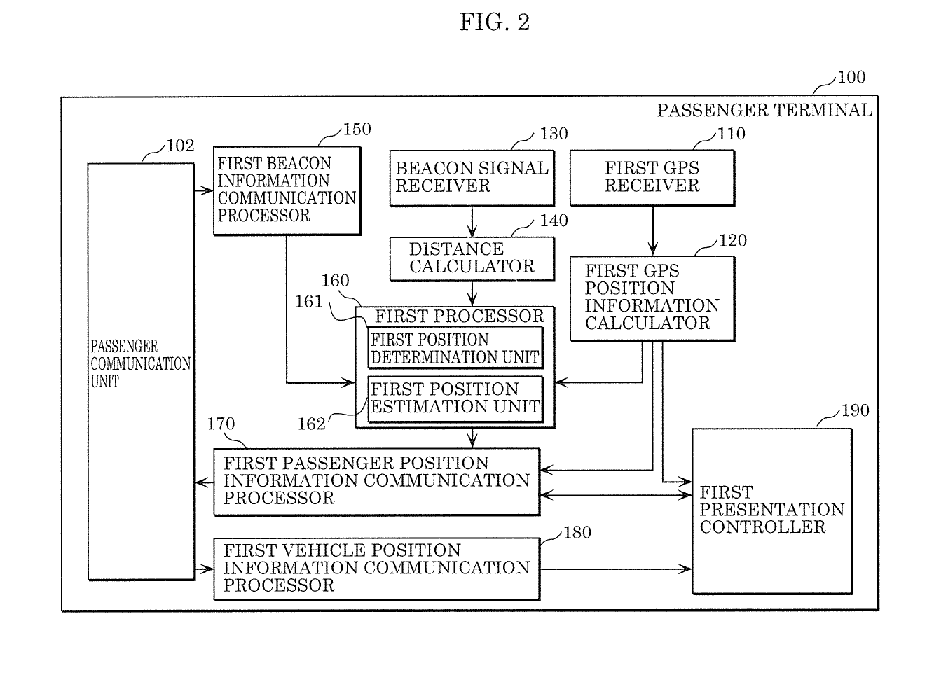

FIG. 2 is a block diagram illustrating the configuration of passenger terminal 100 according to Embodiment 1.

As illustrated in FIG. 2, passenger terminal 100 includes first GPS receiver 110, first GPS position information calculator 120, beacon signal receiver 130, distance calculator 140, first beacon information communication processor 150, first processor 160, first passenger position information communication processor 170, first vehicle position information communication processor 180, first presentation controller 190, and passenger communication unit 102. In the present embodiment, passenger terminal 100 is an example of an information processing device, but may include the information processing device. In such a case, the information processing device may include first GPS receiver 110, passenger communication unit 102, beacon signal receiver 130, first processor 160, and first presentation controller 190. Note that passenger terminal 100 refers not only to a terminal of passenger 10 currently on vehicle 20 but also to a terminal of passenger 10 who intends to get on vehicle 20.

First GPS receiver 110 receives satellite signals transmitted from a plurality of GPS transmitters and each including satellite orbit data necessary for calculating passenger position information indicating a position of passenger terminal 100, and outputs the satellite signals to first GPS position information calculator 120. The passenger position information mentioned here is, for example, coordinates indicating latitude and longitude of passenger terminal 100. The reception and output of the satellite signals including passenger position information are performed at predetermined time intervals. First GPS receiver 110 is an example of an obtaining unit included in passenger terminal 100.

First GPS position information calculator 120 calculates passenger position information indicating a current position of passenger terminal 100, using the satellite signals received by first GPS receiver 110. First GPS position information calculator 120 outputs the calculated passenger position information to first processor 160, first passenger position information communication processor 170, and first presentation controller 190. First GPS position information calculator 120 calculates and outputs the passenger position information every time the passenger position information indicating a current position of passenger terminal 100 is obtained.

When passenger terminal 100 and vehicle terminal 200 are determined to be in a predetermined positional relationship, beacon signal receiver 130 enters a standby status to receive a beacon signal. In this status, beacon signal receiver 130 directly receives a beacon signal transmitted from vehicle terminal 200 at each of a plurality of positions of vehicle terminal 200. Here, “directly” means that a beacon signal is transmitted from vehicle terminal 200 to passenger terminal 100 without having a relay device between vehicle terminal 200 and passenger terminal 100. The beacon signal includes a beacon ID for identifying the beacon signal. Beacon signal receiver 130 measures the radio field intensity of the beacon signal. Beacon signal receiver 130 outputs information indicating the radio field intensity of the beacon signal measured to distance calculator 140. The beacon signal is an example of a signal. Beacon signal receiver 130 is an example of a first communication unit included in passenger terminal 100. The beacon ID is an example of signal identification information.

That passenger terminal 100 and vehicle terminal 200 are in a predetermined positional relationship may mean that a linear distance between passenger terminal 100 and vehicle terminal 200 is within a predetermined range. Rather than a linear distance, the distance between passenger terminal 100 and vehicle terminal 200 may be a distance indicated by a route from vehicle 20 to passenger 10. Depending on the positions of passenger terminal 100 and vehicle terminal 200, vehicle 20 including vehicle terminal 200 may take a detour to head for the place where passenger 10 is. In such a case, the distance indicated by the route from vehicle 20 to passenger 10 is greater than the mere linear distance between the two.

Distance calculator 140 calculates a distance between passenger terminal 100 and vehicle terminal 200 based on the information indicating the radio field intensity obtained from beacon signal receiver 130. The distance between passenger terminal 100 and vehicle terminal 200 can be calculated, using the radio field intensity, the radio attenuation rate, or the like at the position of passenger terminal 100 at the time of reception of the beacon signal. Distance calculator 140 outputs, to first processor 160, distance information indicating the calculated distance between passenger terminal 100 and vehicle terminal 200.

First beacon information communication processor 150 receives beacon information from server 300 via passenger communication unit 102 after a beacon signal is received from vehicle terminal 200. Specifically, first beacon information communication processor 150 requests server 300 for beacon information via passenger communication unit 102 when beacon signal receiver 130 receives a beacon signal. Note that the request for beacon information may be made every time a beacon signal is received or may be made collectively for a plurality of beacon signals.

Beacon information includes (i) a beacon ID for identifying a beacon signal and (ii) vehicle position information (specific vehicle position information) at the time of transmission of the beacon signal by vehicle terminal 200. When first beacon information communication processor 150 obtains the beacon information, it outputs the beacon information to first processor 160.

First processor 160 includes first position determination unit 161 and first position estimation unit 162.

First position determination unit 161 determines whether vehicle terminal 200 and passenger terminal 100 are in a predetermined positional relationship, using the vehicle position information and the passenger position information. When first position determination unit 161 determines that vehicle terminal 200 and passenger terminal 100 are in a predetermined positional relationship, first position determination unit 161 causes beacon signal receiver 130 to start being on standby to receive a beacon signal. First position determination unit 161 is an example of a determination unit included in passenger terminal 100.

First position estimation unit 162 generates corrected passenger position information indicating a corrected position of passenger terminal 100, using passenger position information and a plurality of pairs each including (i) information indicating the radio field intensity of a signal and (ii) specific vehicle position information. The signal is transmitted at one of a plurality of positions of the vehicle terminal. The specific vehicle position information indicates the one of the plurality of positions of the vehicle terminal. Specifically, first position estimation unit 162 obtains the passenger position information from first GPS position information calculator 120. First position estimation unit 162 obtains information indicating the distance between passenger terminal 100 and vehicle terminal 200 from distance calculator 140, and beacon information from first beacon information communication processor 150. First processor 160 calculates the position of passenger terminal 100 using a trilateration method based on three or more pairs each including information indicating the distance between passenger terminal 100 and vehicle terminal 200 and information indicating the position of the vehicle terminal 200 included in the beacon information. That is to say, first position estimation unit 162 generates, using a trilateration method, corrected passenger position information in which the position of passenger terminal 100 indicated by the passenger position information obtained from first GPS position information calculator 120 is corrected. First position estimation unit 162 outputs the corrected passenger position information to first passenger position information communication processor 170. Although first position estimation unit 162 estimates the position of passenger terminal 100 using a trilateration method in the present embodiment, first position estimation unit 162 may estimate the position of passenger terminal 100 using a bilateration method, a quadlateration method, or other multilateration methods. First position estimation unit 162 is an example of a generator included in passenger terminal 100. Note that in the case of a bilateration method, the passenger terminal position information measured by passenger terminal 100 is also used in correcting the passenger position information.

The specific vehicle position information mentioned here indicates vehicle position information obtained by beacon signal receiver 130 when, for example, one vehicle terminal 200 transmits a beacon signal. Thus, the plurality of pairs each including (i) information indicating the radio field intensity of a signal transmitted at one of a plurality of positions of vehicle terminal 200 and (ii) one of a plurality of pieces of specific vehicle position information that indicates the one of the plurality of positions of vehicle terminal 200 refer to pairs used for deriving the position of passenger terminal 100.

Note that beacon signal receiver 130 may receive a beacon signal from each of a plurality of vehicle terminals 200. In such a case, too, beacon signal receiver 130 may measure the radio field intensity of each beacon signal, and distance calculator 140 may calculate the distances between passenger terminal 100 and vehicle terminals 200 based on the radio field intensity of each beacon signal, in the same manner as described above. First processor 160 may calculate the position of passenger terminal 100 based on three or more pairs each including a calculated distance and a position of vehicle terminal 200.

Every time the passenger position information is obtained from first GPS position information calculator 120, first passenger position information communication processor 170 transmits the passenger position information to server 300 via passenger communication unit 102.

When first beacon information communication processor 150 obtains the beacon information, first passenger position information communication processor 170 transmits the corrected passenger position information obtained from first position estimation unit 162 to server 300 via passenger communication unit 102, and also outputs the corrected passenger position information to first presentation controller 190.

First vehicle position information communication processor 180 obtains vehicle position information, which will be described later, from server 300 via passenger communication unit 102 at predetermined time intervals. Every time the vehicle position information is obtained, first vehicle position information communication processor 180 outputs the vehicle position information to first presentation controller 190.

First presentation controller 190 obtains passenger guidance information, and controls presentation, given to passenger terminal 100, of the passenger guidance information for passenger terminal 100. For example, when passenger terminal 100 approaches vehicle terminal 200, first presentation controller 190 may display an enlarged screen on passenger terminal 100 or indicate, using an arrow or the like, the place for meeting the vehicle (hereinafter, also referred to as a destination). The passenger guidance information is presented to passenger terminal 100 to indicate at least one of a distance and route guidance from passenger 10 to the destination. The passenger guidance information includes the vehicle position information and the corrected passenger position information. First presentation controller 190 is an example of a presentation controller included in passenger terminal 100. The passenger guidance information is an example of navigation information.

When the passenger position information is obtained from first passenger position information communication processor 170, first presentation controller 190 may reflect the position indicated by the passenger position information onto a map indicated by the passenger guidance information, and output the resultant map to the display of passenger terminal 100. Also when the vehicle position information is obtained from first vehicle position information communication processor 180, first presentation controller. 190 may reflect the position indicated by the vehicle position information onto the map indicated by the passenger guidance information, and output the resultant map to the display of passenger terminal 100.

Passenger communication unit 102 is a communication interface that wirelessly communicates with server 300 via a network. In the present embodiment, passenger terminal 100 is connected to the network via a base station. Passenger communication unit 102 receives beacon information, vehicle position information, and vehicle guidance information from server 300, and transmits passenger position information and a request for beacon information to server 300. Passenger communication unit 102 is an example of a second communication unit included in passenger terminal 100.

### [Vehicle Terminal]

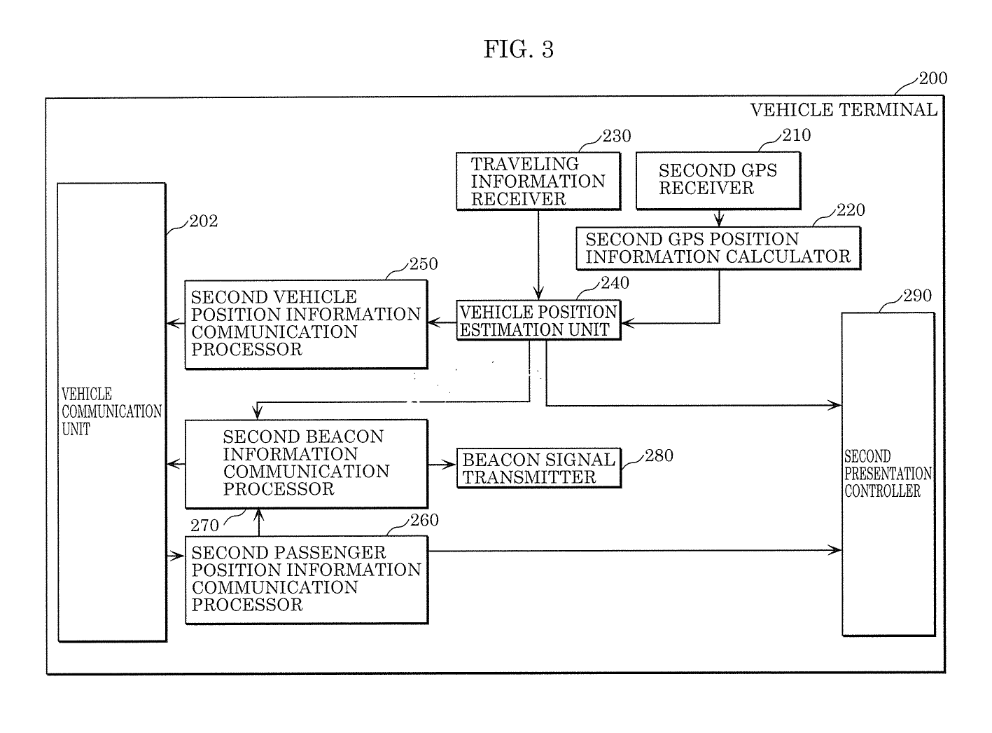

FIG. 3 is a block diagram illustrating the configuration of vehicle terminal 200 according to Embodiment 1.

As illustrated in FIG. 3, vehicle terminal 200 includes second GPS receiver 210, second GPS position information calculator 220, traveling information receiver 230, vehicle position estimation unit 240, second vehicle position information communication processor 250, second passenger position information communication processor 260, second beacon information communication processor 270, beacon signal transmitter 280, second presentation controller 290, and vehicle communication unit 202. In the present embodiment, vehicle terminal 200 is an example of an information processing device, but may include the information processing device. In such a case, the information processing device may include second GPS receiver 210, vehicle communication unit 202, beacon signal transmitter 280, vehicle position estimation unit 240, and second presentation controller 290.

Second GPS receiver 210 receives a satellite signal transmitted from a GPS transmitter and including satellite orbit data necessary for calculating vehicle position information, and outputs the satellite signal to second GPS position information calculator 220. The vehicle position information here is, for example, coordinates indicating latitude and longitude of vehicle terminal 200. The reception and output of the satellite signal including the vehicle position information are performed at predetermined time intervals. Second GPS receiver 210 is an example of an obtaining unit included in vehicle terminal 200.

Second GPS position information calculator 220 generates vehicle position information indicating a current position of vehicle terminal 200, using the satellite signal received by second GPS receiver 210. Second GPS position information calculator 220 outputs the generated vehicle position information to vehicle position estimation unit 240. Second GPS position information calculator 220 generates and outputs vehicle position information every time vehicle position information indicating a current position of vehicle terminal 200 is obtained.

Traveling information receiver 230 receives traveling information indicating, for example, a traveling speed of vehicle terminal 200. The traveling speed indicated by the traveling information is obtained from a speedometer of vehicle 20, for example. Traveling information receiver 230 outputs the traveling information to vehicle position estimation unit 240.

Vehicle position estimation unit 240 estimates a current position of vehicle terminal 200 based on the traveling information and the vehicle position information. Vehicle position estimation unit 240 outputs vehicle position information indicating the estimated position of vehicle terminal 200 to second vehicle position information communication processor 250, second beacon information communication processor 270, and second presentation controller 290.

Second vehicle position information communication processor 250 transmits the vehicle position information to server 300 via vehicle communication unit 202 every time the vehicle position information is obtained from vehicle position estimation unit 240.

Second passenger position information communication processor 260 obtains at least one of passenger position information and corrected passenger position information from server 300 via vehicle communication unit 202 at predetermined time intervals. Second passenger position information communication processor 260 outputs the at least one of passenger position information and corrected passenger position information to second presentation controller 290 every time the corrected passenger position information is obtained.

Second beacon information communication processor 270 determines whether vehicle terminal 200 and passenger terminal 100 are in a predetermined positional relationship, using the vehicle position information and the passenger position information. When vehicle terminal 200 and passenger terminal 100 are determined to be in a predetermined positional relationship, second beacon information communication processor 270 causes beacon signal transmitter 280 to transmit a beacon signal to be directly received by passenger terminal 100. Second beacon information communication processor 270 is an example of a determination unit included in vehicle terminal 200. Specifically, when vehicle terminal 200 and passenger terminal 100 are in a predetermined positional relationship, second beacon information communication processor 270 instructs beacon signal transmitter 280 to transmit a beacon signal at each of a plurality of positions of vehicle terminal 200. After causing beacon signal transmitter 280 to transmit a beacon signal, second beacon information communication processor 270 generates beacon information including (i) vehicle position information at the time of transmission of the beacon signal and (ii) a beacon ID for identifying the beacon signal transmitted. The beacon ID is associated with the vehicle position information. Second beacon information communication processor 270 transmits the beacon information to server 300 via vehicle communication unit 202. Note that if vehicle 20 is traveling, second beacon information communication processor 270 may instruct beacon signal transmitter 280 to transmit a beacon signal at predetermined time intervals. This way, a beacon signal can be transmitted at each of a plurality of positions of vehicle terminal 200.

When vehicle terminal 200 and passenger terminal 100 are determined to be in a predetermined positional relationship, beacon signal transmitter 280 starts transmitting, at each of a plurality of positions of vehicle terminal 200, a beacon signal to be directly received by passenger terminal 100, as instructed by second beacon information communication processor 270. Beacon signal transmitter 280 transmits a beacon signal at predetermined time intervals. Beacon signal transmitter 280 is an example of a first communication unit included in vehicle terminal 200.

Second presentation controller 290 obtains vehicle guidance information, and controls presentation, given to vehicle terminal 200, of vehicle guidance information for vehicle terminal 200. For instance, when vehicle terminal 200 approaches passenger terminal 100, second presentation controller 290 may display an enlarged screen on vehicle terminal 200 or indicate a destination using, for example, an arrow. The vehicle guidance information is presented to vehicle terminal 200 to indicate at least one of a distance and route guidance from the vehicle to the destination. The vehicle guidance information includes vehicle position information and corrected passenger position information. Second presentation controller 290 is an example of a presentation controller included in vehicle terminal 200. The vehicle guidance information is an example of navigation information.

When the passenger position information is obtained from second passenger position information communication processor 260, second presentation controller 290 may reflect the position indicated by the passenger position information onto a map indicated by the passenger guidance information, and output the resultant map to the display of vehicle terminal 200. Moreover, when the passenger position information is obtained from second passenger position information communication processor 260, second presentation controller 290 may reflect the position indicated by the passenger position information onto the map indicated by the vehicle guidance information, and output the resultant map to the display of vehicle terminal 200.

Vehicle communication unit 202 is a communication interface that wirelessly communicates with server 300 via the network. In the present embodiment, vehicle terminal 200 is connected to the network via a base station. Vehicle communication unit 202 transmits vehicle position information and beacon information to server 300 and receives passenger position information and vehicle guidance information from server 300. Vehicle communication unit 202 is an example of a second communication unit included in vehicle terminal 200.

### [Server]

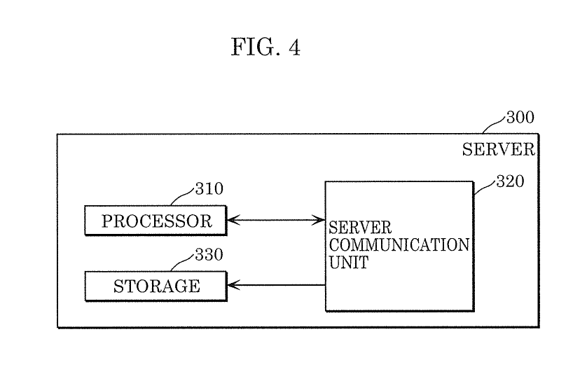

FIG. 4 is a block diagram illustrating the configuration of server 300 according to Embodiment 1.

As illustrated in FIG. 4, server 300 manages information transmitted between passenger terminal 100 and vehicle terminal 200 included in vehicle 20. Server 300 is connected to passenger terminal 100 and vehicle terminal 200 via the network.

Server 300 includes processor 310, server communication unit 320, and storage 330.

Processor 310 generates, based on the passenger position information and the vehicle position information, (i) vehicle guidance information indicating a route from vehicle terminal 200 to passenger terminal 100 and (ii) passenger guidance information indicating a route from passenger terminal 100 to vehicle terminal 200. Processor 310 transmits, via server communication unit 320, the vehicle guidance information to vehicle terminal 200 and the passenger guidance information to passenger terminal 100.

Note that when the passenger position information is not obtained from passenger terminal 100, processor 310 may generate passenger guidance information including information that guides the passenger to enable the passenger position information to be obtained. For example, when first GPS receiver 110 cannot receive a satellite signal, processor 310 generates passenger guidance information including information that prompts the passenger having passenger terminal 100 to go out of doors or move to a place with less buildings or a place with low-rise buildings, and transmits the passenger guidance information to passenger terminal 100 via server communication unit 320.

Server communication unit 320 is a communication interface that receives passenger position information from passenger terminal 100 and transmits the passenger position information to vehicle terminal 200. Server communication unit 320 receives vehicle position information from vehicle terminal 200 and transmits the vehicle position information to passenger terminal 100. Server communication unit 320 repeatedly receives and transmits the passenger position information and the vehicle position information. Server communication unit 320 outputs the passenger position information and the vehicle position information to processor 310 and storage 330.

After vehicle terminal 200 transmits a beacon signal, server communication unit 320 receives beacon information from vehicle terminal 200. The beacon information is stored in storage 330. After vehicle terminal 200 transmits a beacon signal, server communication unit 320 receives from passenger terminal 100 a request for beacon information. Processor 310 reads from storage 330 beacon information including a beacon ID identical to a beacon ID included in the request for beacon information, and server communication unit 320 transmits the beacon information to passenger terminal 100 as a response to the request.

Storage 330 stores the passenger position information, the vehicle position information, and the beacon information obtained from server communication unit 320.

### [Operations]

Next, operations of navigation system 1 according to the present embodiment will be described.

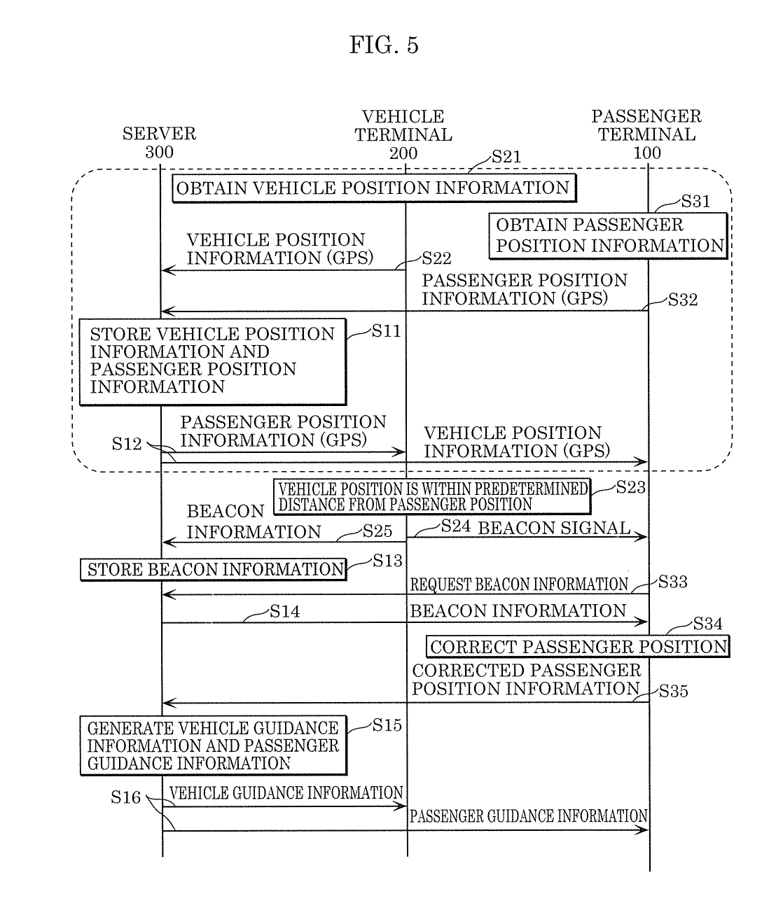

FIG. 5 is a sequence diagram illustrating operations of navigation system 1 according to Embodiment 1.

As illustrated in FIG. 5, first, vehicle terminal 200 obtains vehicle position information indicating its own position using second GPS receiver 210 (S21). Passenger terminal 100 obtains passenger position information indicating its own position using first GPS receiver 110 (S31).

Next, vehicle terminal 200 transmits the vehicle position information to server 300 (S22). Passenger terminal 100 transmits the passenger position information to server 300 (S32). Note that Step S22 and Step S32 may be reversed in order, or server 300 may receive both the vehicle position information and the passenger position information at the same time.

Next, server 300 stores the vehicle position information and the passenger position information in storage 330 (S11).

Next, server 300 transmits the passenger position information to vehicle terminal 200 and transmits the vehicle position information to passenger terminal 100 (S12). The processing in the region indicated by a dashed line in FIG. 5 is repeatedly performed at predetermined time intervals.

Next, after receiving the passenger position information, vehicle terminal 200 determines whether vehicle terminal 200 and passenger terminal 100 are in a predetermined positional relationship. FIG. 5 assumes that vehicle terminal 200 and passenger terminal 100 are in a predetermined positional relationship; in other words, vehicle terminal 200 is in a predetermined distance from passenger terminal 100. Accordingly, after determining that vehicle terminal 200 is in the predetermined distance from passenger terminal 100 (S23), vehicle terminal 200 starts transmitting a beacon signal to passenger terminal 100 (S24).

Next, vehicle terminal 200 generates beacon information including (i) a beacon ID for identifying the beacon signal and (ii) vehicle position information at the time of transmission of the beacon signal by vehicle terminal 200, and transmits the beacon information to server 300 (S25).

Next, server 300 stores the beacon information in storage 330 (S13).

When passenger terminal 100 receives the beacon signal transmitted from vehicle terminal 200 in Step S24, passenger terminal 100 transmits a request for beacon information to server 300 (S33).

Next, when server 300 receives the request for beacon information from passenger terminal 100 in Step S33, server 300 reads, from storage 330, beacon information including a beacon ID identical to the beacon ID included in the request for beacon information, and transmits the beacon information to passenger terminal 100 as a response to the request (S14).

Next, every time passenger terminal 100 receives a beacon signal transmitted in Step S24, passenger terminal 100 generates corrected passenger position information in which the passenger position is corrected based on the beacon information and the radio field intensity (S34).

Next, passenger terminal 100 transmits the corrected passenger position information to server 300 (S35).

Next, server 300 generates vehicle guidance information and passenger guidance information based on the vehicle position information and the corrected passenger position information (S15), and stores the vehicle guidance information and the passenger guidance information in storage 330.

Next, server 300 transmits the vehicle guidance information to vehicle terminal 200, and transmits the passenger guidance information to passenger terminal 100 (S16). Then, navigation system 1 finishes the processing.

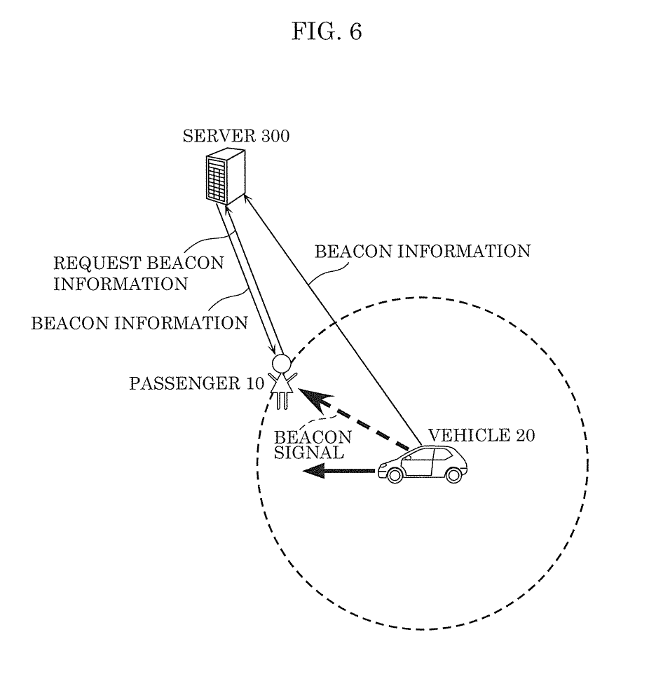

With reference to FIG. 6, the following describes processing in Steps S24, S25, S33, and S14 in FIG. 5.

FIG. 6 is a schematic diagram illustrating transmission of a beacon signal and beacon information, performed when passenger terminal 100 and vehicle terminal 200 according to Embodiment 1 are in the predetermined positional relationship. Although passenger terminal 100 and vehicle terminal 200 are not illustrated in FIG. 6, it is assumed that passenger terminal 100 is carried by the passenger and vehicle 20 is included in vehicle terminal 200. FIG. 6 is an example case where vehicle 20 travels toward the passenger. The present disclosure is not limited to the example case illustrated in FIG. 6. For example, passenger terminal 100 may travel toward vehicle terminal 200, or passenger terminal 100 and vehicle terminal 200 may travel toward the destination.

For example, as indicated by a circular dashed line in FIG. 6, the predetermined positional relationship between passenger terminal 100 and vehicle terminal 200 is a relationship in which passenger terminal 100 is in a predetermined region from vehicle terminal 200, in other words, in a predetermined distance from vehicle terminal 200. For example, when vehicle terminal 200 approaches passenger terminal 100, that is, when passenger terminal 100 is within a predetermined distance from vehicle terminal 200, vehicle terminal 200 transmits a beacon signal to passenger terminal 100, and beacon information to server 300. Passenger terminal 100 can obtain the beacon information via server 300.

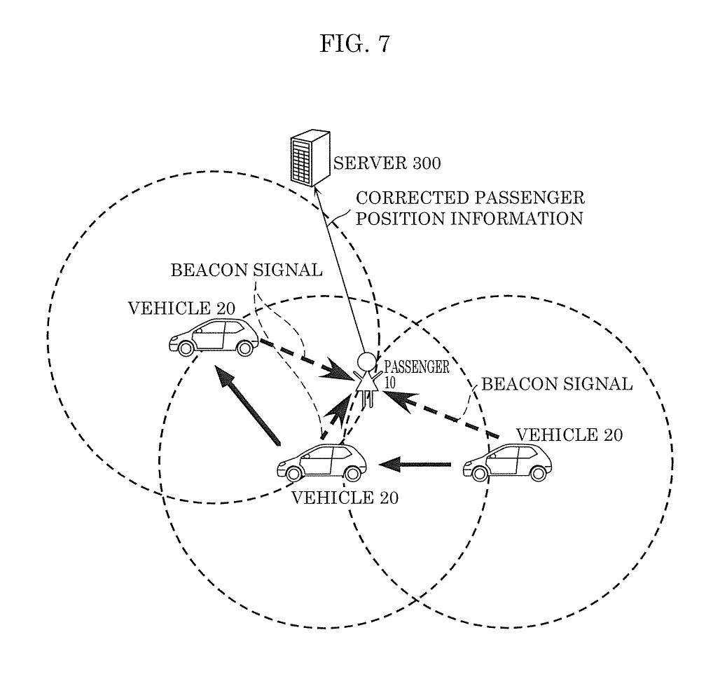

Next, the corrected passenger position information generated in Step S34 in FIG. 5 will be described with reference to FIG. 7.

FIG. 7 is a schematic diagram illustrating how passenger terminal 100 according to Embodiment 1 estimates the position of passenger terminal 100 using beacon signals transmitted by vehicle terminal 200 at different positions. FIG. 7 assumes that passenger 10 is stationary and vehicle 20 is traveling. In FIG. 7, the position of passenger terminal 100 is estimated using a trilateration method.

FIG. 7 illustrates an example case where one vehicle terminal 200, which is currently traveling, transmits a beacon signal at three different positions. By repeating the reception of a beacon signal in Step S24 and the reception of beacon information in Step S14 in FIG. 5, passenger terminal 100 generates distance information indicating the distances between passenger terminal 100 and the three positions of vehicle terminal 200. Passenger terminal 100 can calculate its own position using a trilateration method based on the distance information indicating the distances between passenger terminal 100 and the three positions and the position information of vehicle terminal 200. Note that in FIG. 7, the beacon signals are transmitted from the same vehicle terminal 200 at a plurality of positions, but may be transmitted from mutually different vehicle terminals 200.

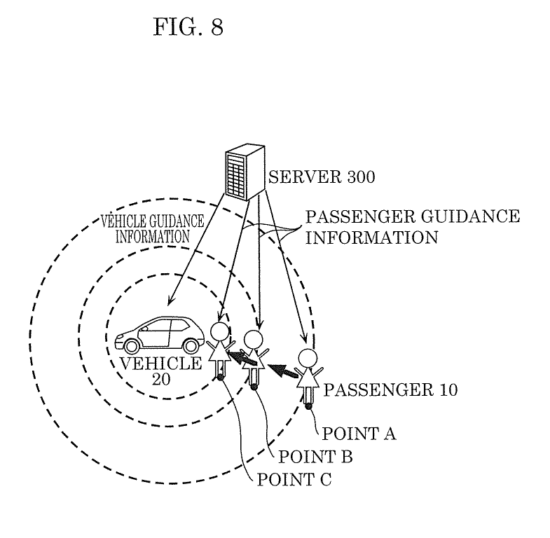

Next, with reference to FIG. 8, the vehicle guidance information and the passenger guidance information generated by server 300 in Step S16 of FIG. 5 will be described.

FIG. 8 is a schematic diagram illustrating an example case of continuously updating the corrected position of passenger terminal 100 when passenger 10 according to Embodiment 1 is traveling toward vehicle 20. FIG. 8 assumes that vehicle 20 has arrived at the destination and is waiting, whereas passenger 10 is approaching vehicle 20. The present disclosure is not limited to the example illustrated in FIG. 8, and also encompasses, for example, the case where vehicle terminal 200 approaches passenger terminal 100, and the case where passenger terminal 100 and vehicle terminal 200 both approach the destination.

First, assume that after the position of passenger terminal 100 is corrected as illustrated in FIG. 7, passenger 10, i.e., passenger terminal 100, is at point A as illustrated in FIG. 8. Since server 300 transmits first vehicle guidance information to vehicle terminal 200 and first passenger guidance information to passenger terminal 100 in Step S16, passenger 10 starts travelling toward the destination where vehicle 20 is, according to the first passenger guidance information.

When passenger terminal 100 travels to point B, i.e., a position closer to vehicle terminal 200, a beacon signal is transmitted by vehicle terminal 200 and received by passenger terminal 100 in Step S24 in FIG. 5, and beacon information is received by passenger terminal 100 in Step S14. Passenger terminal 100 calculates the distance from vehicle terminal 200 based on the radio field intensity of the beacon signal received and the vehicle position information included in the beacon information to further update the corrected position of passenger terminal 100. Passenger terminal 100 transmits the updated, corrected position information of passenger terminal 100 to server 300. Then, server 300 updates the vehicle guidance information and the passenger guidance information using the updated, corrected position information of passenger terminal 100, and transmits second vehicle guidance information to vehicle terminal 200 and second passenger guidance information to passenger terminal 100. By the nature of beacon signals, the radio field intensity of passenger terminal 100 increases with a decrease in the distance between passenger terminal 100 and vehicle terminal 200, and thus, passenger terminal 100 can estimate its own position more accurately. The second vehicle guidance information and the second passenger guidance information, which are more precise than the first vehicle guidance information and the first passenger guidance information, are displayed on passenger terminal 100.

When passenger terminal 100 further moves to point C, a position further closer to vehicle terminal 200, a beacon signal is transmitted by vehicle terminal 200 and received by passenger terminal 100 in Step S24 in FIG. 5, and beacon information is received by passenger terminal 100 in Step S14. As with point B, passenger terminal 100 calculates the distance from vehicle terminal 200 based on the radio field intensity of the beacon signal received and the vehicle position information included in the beacon information to further update the corrected position of passenger terminal 100. Passenger terminal 100 transmits the updated, corrected position information of passenger terminal 100 to server 300. Server 300 updates the vehicle guidance information and the passenger guidance information using the updated, corrected position information of passenger terminal 100, and transmits third vehicle guidance information to vehicle terminal 300 and third passenger guidance information to passenger terminal 100. The third vehicle guidance information and the third passenger guidance information, which are more precise than the first and second vehicle guidance information and the first and second passenger guidance information, are displayed on passenger terminal 100.

Accordingly, since the radio field intensity of passenger terminal 100 increases as passenger terminal 100 approaches vehicle terminal 200, passenger terminal 100 updates the corrected passenger position information that is corrected using a trilateration method and transmits the updated, corrected passenger position information to server 300 every time a beacon signal is received. By generating the guidance information based on, for example, the updated, corrected passenger position information, server 300 can more accurately guide passenger terminal 100 or vehicle terminal 200, i.e., passenger 10 or vehicle 20, to the destination.

Note that the beacon information need not be used in the above-described update of the corrected passenger position information.

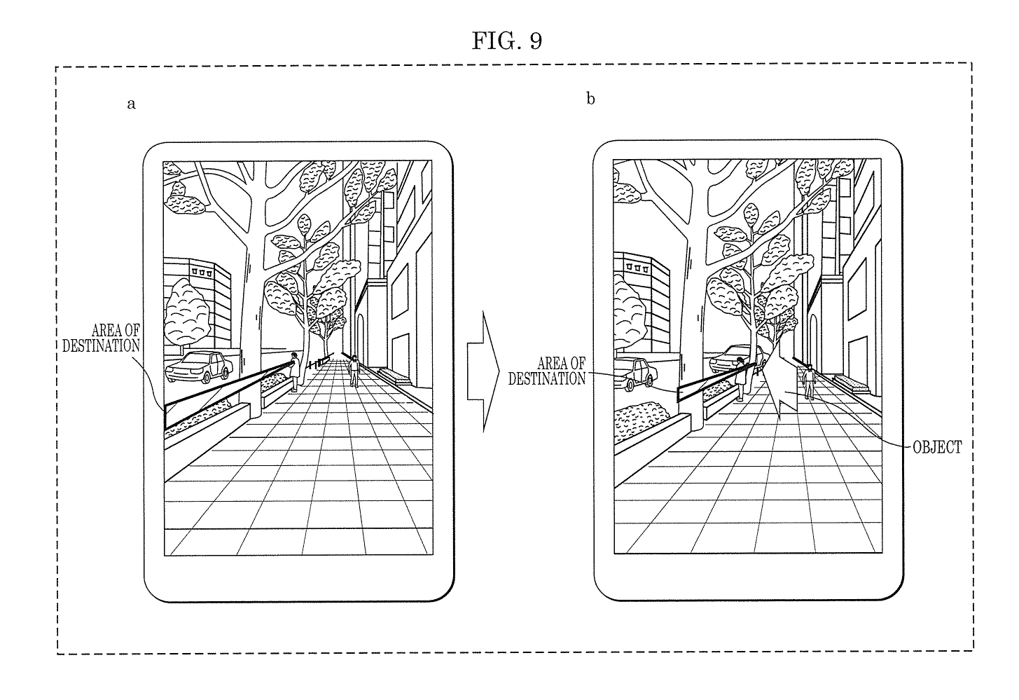

Next, the passenger guidance information displayed on passenger terminal 100 will be described with reference to FIG. 9.

FIG. 9 is a schematic diagram illustrating the passenger guidance information displayed on passenger terminal 100 according to Embodiment 1. In part a of FIG. 9, an area in which vehicle 20 is to arrive, that is, an area of destination, is displayed on passenger terminal 100. The area of destination is displayed to guide passenger 10 to the destination, and is indicated by diagonal hatching.

Part b of FIG. 9 illustrates an area of destination when the precision of the destination has improved compared to part a of FIG. 9 as a result of correction of the passenger position information. As illustrated in part b of FIG. 9, the area of destination smaller than that in part a of FIG. 9 is displayed on passenger terminal 100, in other words, the area of destination is narrowed down. In addition, an object for guiding the passenger to the area of destination may be displayed on passenger terminal 100. For instance, an arrow is displayed as the object in the example illustrated in part b of FIG. 9.

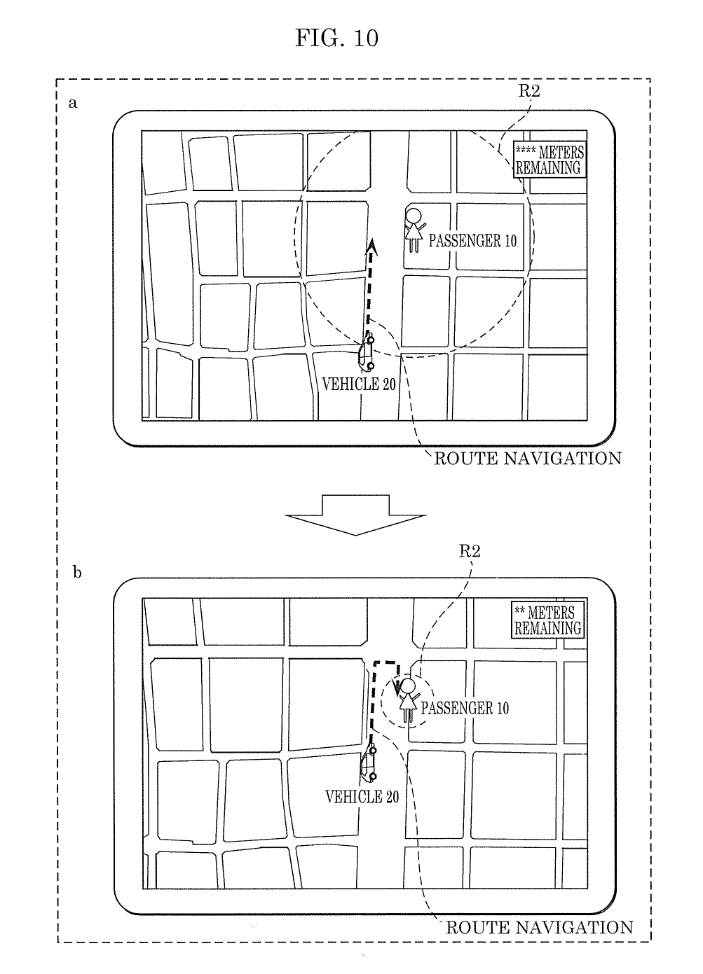

Next, the vehicle guidance information displayed on vehicle terminal 200 will be described with reference to FIG. 10.

FIG. 10 is a schematic diagram illustrating the vehicle guidance information displayed on vehicle terminal 200 according to Embodiment 1. Part a of FIG. 10 illustrates first vehicle guidance information. As illustrated in part a of FIG. 10, route guidance indicating a route from vehicle 20 to the destination (here, the position of passenger terminal 100) is displayed on vehicle terminal 200. The route guidance is indicated by a bold dashed line. The position of passenger terminal 100 is indicated by thin dashed line R2. The position of passenger terminal 100 is shown as an area rather than a point, because an error is contained. The passenger guidance information indicates at least one of the distance and the route guidance from the position of vehicle terminal 200 to the corrected position of the passenger terminal. In the present embodiment, the passenger guidance information indicates the distance and the route guidance. The route guidance is an example of a route.

Part b of FIG. 10 illustrates second vehicle guidance information displayed when vehicle terminal 200 gets closer to passenger terminal 100 as compared to part a of FIG. 10. As illustrated in part b of FIG. 10, route guidance from vehicle 20 to the destination is displayed on vehicle terminal 200.

Since the precision of detecting the position of passenger terminal 100 increases, i.e., the error decreases, with a decrease in the distance between vehicle terminal 200 and passenger terminal 100, the area surrounded by thin dashed line R2 is smaller in part b of FIG. 10 than in part a of FIG. 10. As a result, vehicle 20 can be guided closer to passenger terminal 100, allowing passenger 10 and vehicle 20 to meet one another smoothly.

Next, operations of vehicle terminal 200 according to the present embodiment will be described.

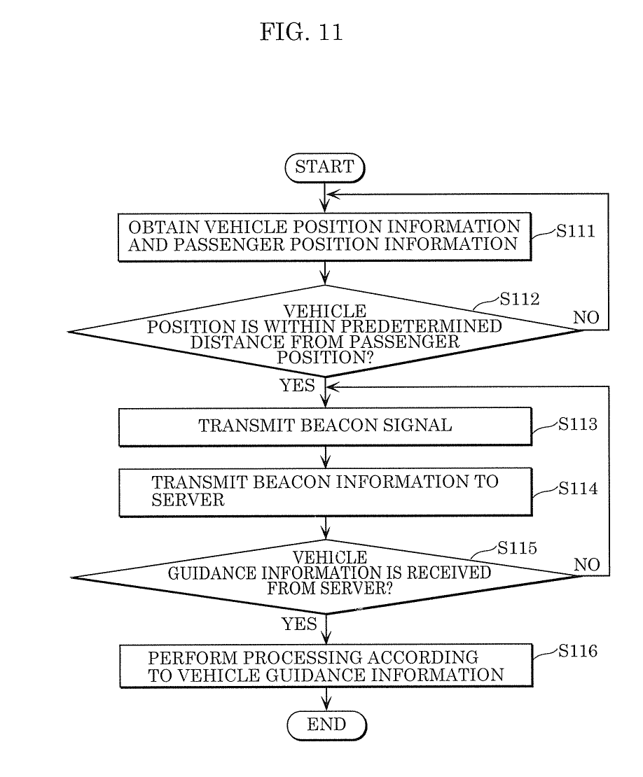

FIG. 11 is a flow chart illustrating operations of vehicle terminal 200 according to Embodiment 1. In FIG. 11, vehicle terminal 200 and passenger terminal 100 are considered to be in a predetermined positional relationship when the vehicle position is within a predetermined distance from the passenger position.

As illustrated in FIG. 11, first, vehicle terminal 200 obtains vehicle position information indicating a position of vehicle terminal 200 via second GPS receiver 210, and obtains passenger position information from server 300 (S111).

Next, second beacon information communication processor 270 determines whether the vehicle position is within a predetermined distance from the passenger position (S112).

If the vehicle position is not within the predetermined distance from the passenger position (NO in S112), vehicle terminal 200 brings the processing back to Step S111.

If the vehicle position is within the predetermined distance from the passenger position (YES in S112), beacon signal transmitter 280 transmits a beacon signal (S113).

Next, second beacon information communication processor 270 transmits beacon information to server 300 (S114).

Next, second presentation controller 290 determines whether vehicle guidance information is received (S115).

If second presentation controller 290 has received the vehicle guidance information (YES in S115), second presentation controller 290 performs processing according to the vehicle guidance information received (S116). With this, vehicle terminal 200 displays the vehicle guidance information. Vehicle terminal 200 ends the processing.

On the other hand, if second presentation controller 290 has not received the vehicle guidance information (NO in S115), second presentation controller 290 brings the processing back to Step S113.

Next, operations of passenger terminal 100 according to the present embodiment will be described.

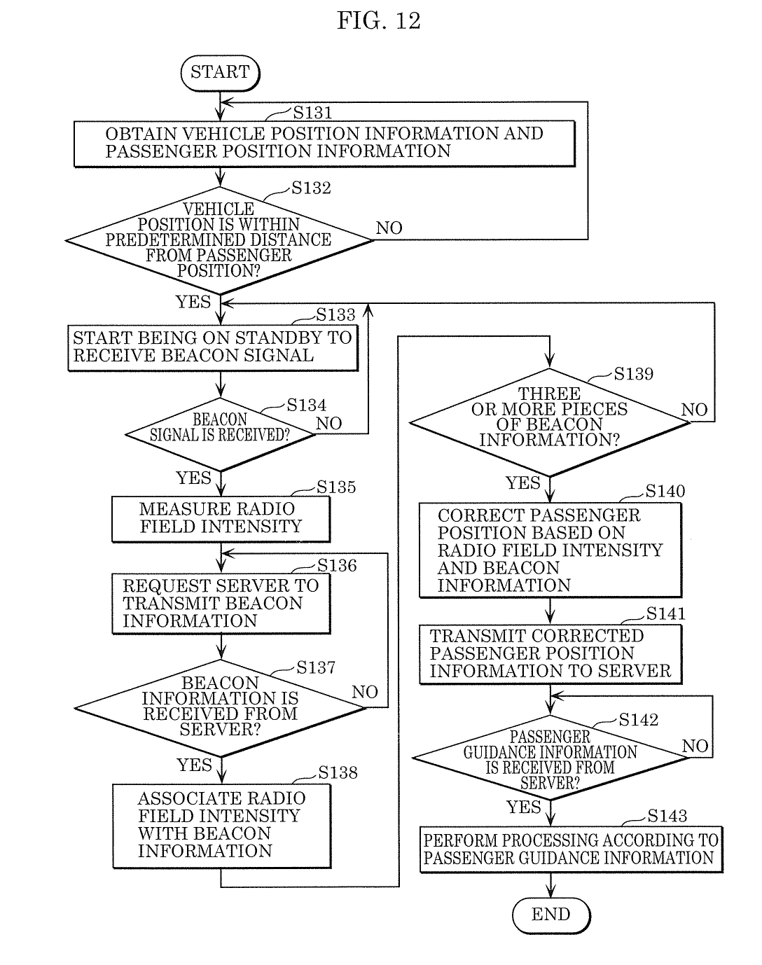

FIG. 12 is a flow chart illustrating operations of passenger terminal 100 according to Embodiment 1.

As illustrated in FIG. 12, first, passenger terminal 100 obtains passenger position information indicating a position of passenger terminal 100 via first GPS receiver 110, and obtains vehicle position information from server 300 (S131).

Next, first position determination unit 161 determines whether the vehicle position is within a predetermined distance from the passenger position (S132).

If the vehicle position is not within the predetermined distance from the passenger position (NO in S132), passenger terminal 100 brings the processing back to Step S131.

If the vehicle position is within the predetermined distance from the passenger position (YES in S132), traveling information receiver 230 starts being on standby to receive a beacon signal (S133).

Next, second passenger position information communication processor 260 determines whether a beacon signal is received (S134).

If a beacon signal is not received (NO in S134), passenger terminal 100 brings the processing back to Step S133.

If a beacon signal is received (YES in S134), beacon signal receiver 130 measures the radio field intensity of the beacon signal received (S135).

Next, passenger terminal 100 requests server 300 to transmit beacon information including a beacon ID identical to a beacon ID indicated by the beacon signal received (S136).

Next, first beacon information communication processor 150 determines whether beacon information is received from server 300 (S137).

If beacon information is not received (NO in S137), passenger terminal 100 brings the processing back to Step S136.

If beacon information is received (YES in S137), first processor 160 associates the beacon information with the radio field intensity measured in Step S135 (S138).

Next, first beacon information communication processor 150 determines whether three or more pieces of beacon information are received (S139). Note that although first beacon information communication processor 150 determines whether three or more pieces of beacon information are received, this is a mere example, and first beacon information communication processor 150 may determine whether two pieces of beacon information are received. In such a case, narrowing down of the passenger position may be insufficient, and thus, passenger terminal 100 may correct the passenger position information by further using information, such as road information, indicating an area in which the vehicle that has transmitted a beacon signal is likely located.

If three or more pieces of beacon information are not received (NO in S139), passenger terminal 100 brings the processing back to Step S133.

If three or more pieces of beacon information are received (YES in S139), first position estimation unit 162 generates corrected passenger position information in which the passenger position is corrected based on the radio field intensities of the beacon signals and the three or more pieces of beacon information (S140).

Next, first position estimation unit 162 transmits the corrected passenger position information to server 300 (S141).

Next, first presentation controller 190 determines whether passenger guidance information is received (S142).

If first presentation controller 190 has not received the passenger guidance information (NO in S142), first presentation controller 190 repeats this processing.

On the other hand, if first presentation controller 190 has received the passenger guidance information (YES in S142), first presentation controller 190 performs processing according to the passenger guidance information received (S143). Then, passenger terminal 100 ends the processing.

Next, operations of server 300 according to the present embodiment will be described.

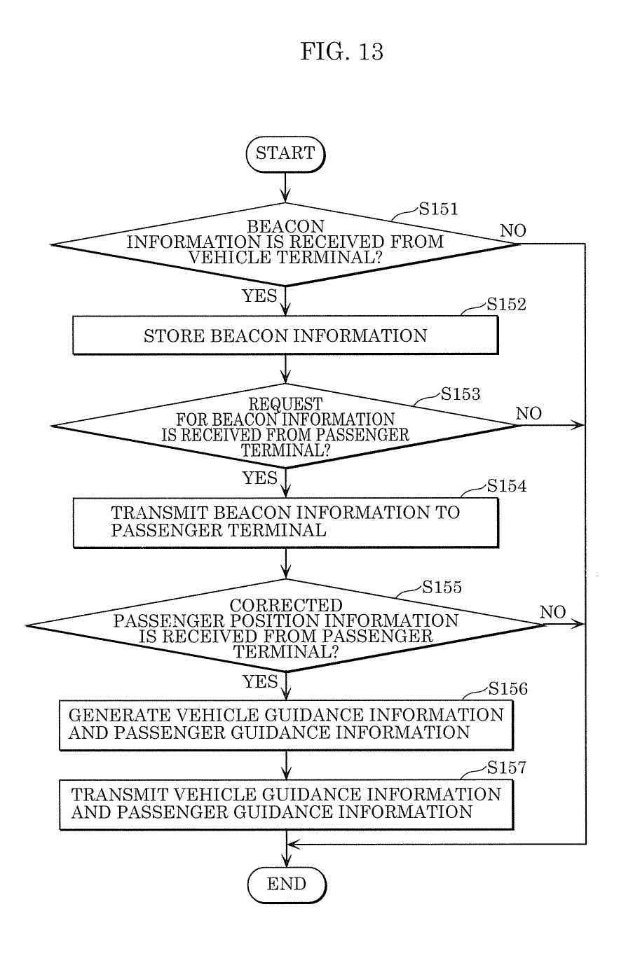

FIG. 13 is a flow chart illustrating operations of server 300 according to Embodiment 1.

As illustrated in FIG. 13, first, server 300 determines whether beacon information is received from vehicle terminal 200 (S151).

If server 300 has not received beacon information from vehicle terminal 200 (NO in S151), server 300 ends the processing. Server 300 may start the processing all over again.

If server 300 has received beacon information from vehicle terminal 200 (YES in S151), server 300 stores the beacon information in storage 330 (S152).

Next, server 300 determines whether a request for beacon information is received from passenger terminal 100 (S153).

If a request for beacon information is not received from passenger terminal 100 (NO in S153), server 300 ends the processing. Server 300 may start the processing all over again.

If a request for beacon information is received from passenger terminal 100 (YES in S153), processor 310 reads from storage 330 beacon information including a beacon ID identical to a beacon ID included in the request for beacon information. Processor 310 transmits the beacon information to passenger terminal 100 via server communication unit 320 (S154).

Next, server 300 determines whether corrected passenger position information is received from passenger terminal 100 (S155).

If corrected passenger position information is not received from passenger terminal 100 (NO in S155), server 300 ends the processing. Server 300 may start the processing all over again.

If corrected passenger position information is received from passenger terminal 100 (YES in S155), processor 310 of server 300 generates vehicle guidance information and passenger guidance information based on vehicle position information and the corrected passenger position information (S156).

Next, server 300 transmits the vehicle guidance information and the passenger guidance information (S157). Then, server 300 ends the processing.

As described above, in navigation system 1, vehicle terminal 200 receives passenger position information at predetermined time intervals, and passenger terminal 100 receives vehicle position information at predetermined time intervals, thus allowing vehicle terminal 200 and passenger terminal 100 to share the vehicle position information and the passenger position information with one another. When vehicle terminal 200 and passenger terminal 100 are in a predetermined positional relationship, server 300 generates vehicle guidance information and passenger guidance information, and transmits the vehicle guidance information to vehicle terminal 200 and the passenger guidance information to passenger terminal 100. This way, passenger 10 travels according to the guidance given by the passenger guidance information and vehicle 20 travels according to the guidance given by the vehicle guidance information, thereby allowing passenger 10 to get on vehicle 20 smoothly.

### Embodiment 2

### [Configuration]

The configurations of information processing devices and an information processing method according to the present embodiment are the same as those in Embodiment 1 unless otherwise stated. The same structural elements share the same reference signs, and detailed descriptions thereof are omitted.

Vehicle position estimation unit 240 outputs traveling information obtained by traveling information receiver 230 to second beacon information communication processor 270. The traveling information indicates a traveling speed of vehicle terminal 200 or a change in the position of vehicle terminal 200.

Second beacon information communication processor 270 obtains the traveling information regarding traveling of vehicle 20, and controls signal transmission intervals based on the traveling information. Second beacon information communication processor 270 shortens the transmission intervals as the traveling speed increases or as the change in the position of vehicle terminal 200 increases. For example, the degree of change may be determined according to the amount of change or the rate of change.

### [Operations]

Next, operations of vehicle terminal 200 according to the present embodiment will be described.

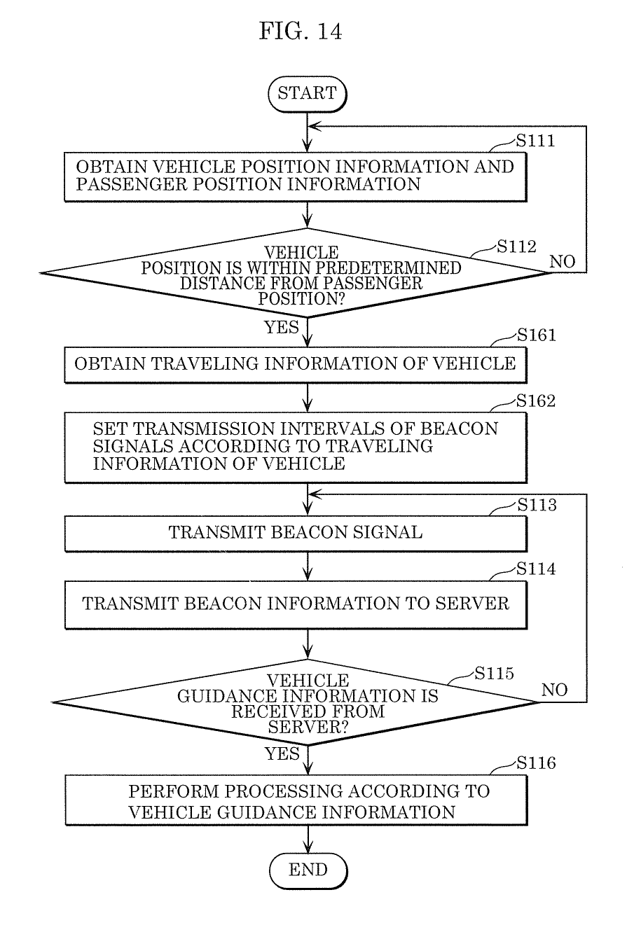

FIG. 14 is a flow chart illustrating operations of vehicle terminal 200 according to Embodiment 2. In FIG. 14, vehicle terminal 200 and passenger terminal 100 are considered to be in a predetermined positional relationship when the vehicle position is within a predetermined distance from the passenger position.

In FIG. 14, the processing identical to that in FIG. 11 are given the same reference signs, and the descriptions thereof are omitted as appropriate.

As illustrated in FIG. 14, first, vehicle terminal 200 performs the processing in Steps S111 and S112.

If the vehicle position is within a predetermined distance from the passenger position (YES in S112), vehicle terminal 200 receives traveling information of vehicle 20 from server 300 (S161).

Next, second beacon information communication processor 270 sets transmission intervals of beacon signals according to the traveling information of the vehicle (S162). Then, vehicle terminal 200 performs Steps S113 through S116 and ends the processing.

In such a manner as described, in navigation system 1, the transmission intervals of beacon signals are controlled according to the traveling information. For example, when vehicle terminal 200 is not travelling, that is, when transmission of beacon signals is not likely to be helpful in correcting the passenger position information, second beacon information communication processor 270 increases the transmission intervals of beacon signals. This enables power savings and effective use of communication bands in vehicle terminal 200. Conversely, when vehicle terminal 200 is travelling at high speed, second beacon information communication processor 270 shortens the transmission intervals of beacon signals. This makes it possible to cover failure of beacon signal reception by passenger terminal 100. Accordingly, for example, even when passenger terminal 100 has failed to receive a signal, as long as passenger terminal 100 can receive another signal transmitted within a short transmission interval, it is possible to reduce the risk of passenger terminal 100 failing to receive all the beacon signals used for correcting the passenger terminal position.

### Other Variations

Although information processing devices and an information processing method according to Embodiments 1 and 2 of the present disclosure have been described above, the embodiments of the present disclosure are not limited to Embodiments 1 and 2.

For example, with the information processing devices and the information processing method according to the above embodiments, vehicle position estimation unit 240 may calculate the traveling speed of vehicle terminal 200 based on a plurality of pieces of vehicle position information calculated by second GPS position information calculator 220. For example, by obtaining consecutively-obtained two pieces of vehicle position information from second GPS position information calculator 220, vehicle position estimation unit 240 can calculate the speed based on (i) the distance between two vehicle terminals 200 indicated by the two pieces of vehicle position information and (ii) the difference between the time points added to the two pieces of vehicle position information. Moreover, vehicle position estimation unit 240 can calculate a change in the position of the vehicle terminal based on the consecutively-obtained two pieces of vehicle position information.

With the information processing devices and the information processing method according to the above embodiments, when vehicle 20 approaches the destination, first presentation controller 190 may inform, by sound, that vehicle 20 is approaching. Moreover, when passenger 10 approaches the destination, second presentation controller 290 may inform, by sound, that passenger 10 is approaching.

The information processing device according to the above embodiments may be a device independent of vehicle terminal 200. For example, the information processing device may include second GPS position information calculator 220, vehicle position estimation unit 240, second vehicle position information communication processor 250, second passenger position information communication processor 260, and second beacon information communication processor 270, and may cooperate with second GPS receiver 210, traveling information receiver 230, beacon signal transmitter 280, second presentation controller 290, and vehicle communication unit 202 of vehicle terminal 200.

The above embodiments have illustrated the example of displaying the vehicle guidance information in a mode adapted to a change in the corrected passenger position information; however, the passenger guidance information may be displayed in a mode adapted to a change in the corrected passenger position information.

Moreover, each processing member included in the information processing devices and the information processing method according to the above embodiments is implemented as an LSI (large-scale integrated circuit) which is typically an integrated circuit. The integrated circuits may be implemented in a single chip individually, or in a single chip that includes some or all of them.

Moreover, the method of circuit integration is not limited to LSI. Integration may be realized with a specialized circuit or a general purpose processor. A field-programmable gate array (FPGA) for which programming can be performed after an LSI is fabricated or a reconfigurable processor capable of reconfiguring connections and settings of circuit cells of an LSI may be used, instead.

Note that each of the structural elements in each of the above embodiments may be configured in the form of an exclusive hardware product, or may be implemented by executing a software program suitable for the structural element. Each of the structural elements may be implemented by means of a program executing unit, such as a CPU or a processor, reading and executing the software program recorded on a recording medium such as a hard disk or a semiconductor memory.

Moreover, an aspect of the present disclosure may be implemented as an information processing device and also as a program that causes a computer to execute an information processing method.

Numbers in the above description are examples used for specifically describing the present disclosure, and the present disclosure is not limited by such numbers.

Moreover, the block diagrams illustrate one example of the division of functional blocks: a plurality of functional blocks may be implemented as a single functional block, a single functional block may be broken up into a plurality of functional blocks, and part of one function may be transferred to another functional block. In addition, functions of a plurality of functional blocks having similar functions may be processed in parallel or by time-division by a single hardware or software product.

Furthermore, since the processing order of the steps in each flow chart is one example given for specifically describing the present disclosure, other processing orders may be adopted. In addition, a part of the steps may be performed simultaneously (in parallel) with another step.

While the foregoing has described information processing devices and a program according to one or more aspects of the present disclosure based on Embodiments 1 and 2, Embodiments 1 and 2 are not limited to the one or more aspects. Various modifications to Embodiments 1 and 2 conceivable to those skilled in the art, as well as embodiments resulting from combinations of structural elements in different embodiments may be included within the scope of the one or more aspects of the present disclosure, so long as they do not depart from the essence of the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to devices such as a vehicle, a mobile terminal, and a server, or to a system including these devices.

What is claimed is:

1. An information processing device included in a vehicle terminal in a vehicle, the information processing device configured to:
obtain vehicle position information indicating a position of the vehicle terminal;
transmit, at each of a plurality of positions of the vehicle terminal, a signal to be received directly by a passenger terminal of a passenger who intends to get on the vehicle;
transmit, to a server, a plurality of pieces of specific vehicle position information each indicating one of the plurality of positions of the vehicle terminal; and
receive, from the server, corrected passenger position information indicating a corrected position of the passenger terminal after the signal is transmitted at each of the plurality of positions of the vehicle terminal.

2. The information processing device according to claim 1, further configured to
determine whether the vehicle terminal and the passenger terminal are in a predetermined positional relationship, using the vehicle position information and passenger position information indicating a position of the passenger terminal, wherein
the information processing device is configured to start transmitting the signal when it is determined that the vehicle terminal and the passenger terminal are in the predetermined positional relationship.

3. The information processing device according to claim 1, wherein
the signal includes signal identification information for identifying the signal.

4. The information processing device according to claim 1, further configured to
obtain, from the vehicle terminal, traveling information regarding traveling of the vehicle, and control transmission intervals of the signal based on the traveling information.

5. The information processing device according to claim 4, wherein
the traveling information indicates a traveling speed of the vehicle terminal or a change in the position of the vehicle terminal, and
the information processing device is configured to shorten the transmission intervals as the traveling speed increases or as the change in the position of the vehicle terminal increases.

6. The information processing device according to claim 1, further configured to:
control presentation of navigation information for the vehicle terminal; and
receive the navigation information from the server, wherein
the navigation information includes information indicating navigation based on the vehicle position information and the corrected passenger position information, and
the information processing device is configured to change a presentation mode of the navigation information according to a change in the corrected passenger position information.

7. The information processing device according to claim 6, wherein
the navigation information indicates at least one of a distance and a route from the position of the vehicle terminal to the corrected position of the passenger terminal indicated by the corrected passenger position information.

8. The information processing device according to claim 1, wherein
the signal is a beacon signal.

9. An information processing device included in a passenger terminal of a passenger who intends to get on a vehicle, the information processing device configured to:
obtain passenger position information indicating a position of the passenger terminal;
directly receive a signal transmitted from a vehicle terminal at each of a plurality of positions of the vehicle terminal, and measure a radio field intensity of the signal, the vehicle terminal being included in the vehicle;
generate corrected passenger position information indicating a corrected position of the passenger terminal, using the passenger position information and a plurality of pairs each including (i) information indicating the radio field intensity of the signal transmitted at one of the plurality of positions of the vehicle terminal and (ii) one of a plurality of pieces of specific vehicle position information that indicates the one of the plurality of positions of the vehicle terminal; and
receive the plurality of pieces of specific vehicle position information from a server, and transmit the corrected passenger position information to the server.

10. The information processing device according to claim 9, further configured to:
receive vehicle position information indicating a position of the vehicle terminal;
determine whether the vehicle terminal and the passenger terminal are in a predetermined positional relationship, using the vehicle position information and the passenger position information; and
start being on standby to receive the signal from the vehicle terminal when it is determined that the vehicle terminal and the passenger terminal are in the predetermined positional relationship.

11. The information processing device according to claim 9, wherein
the signal includes signal identification information for identifying the signal, and
after receiving the signal transmitted at each of the plurality of positions of the vehicle terminal, the information processing device is configured to transmit the signal identification information of each signal and a request for the plurality of pieces of specific vehicle position information, and receive the plurality of pieces of specific vehicle position information as a response to the request.

12. The information processing device according to claim 10, further configured to:
control presentation of navigation information for the passenger terminal; and
receive the navigation information from the server, wherein
the navigation information includes information indicating navigation based on the vehicle position information and the corrected passenger position information.

13. The information processing device according to claim 9, wherein
the signal is transmitted from a plurality of mutually different vehicle terminals or from the vehicle terminal that performs a plurality of signal transmissions, the plurality of mutually different vehicle terminals each being the vehicle terminal.

14. An information processing method, comprising:
receiving, from a vehicle terminal in a vehicle, vehicle position information indicating a position of the vehicle terminal;
receiving, from a passenger terminal of a passenger who intends to get on the vehicle, passenger position information indicating a position of the passenger terminal;
when the vehicle terminal and the passenger terminal are in a predetermined positional relationship, (i) receiving, from the vehicle terminal, (i-a) a plurality of pieces of signal identification information each for identifying a signal transmitted from the vehicle terminal at each of a plurality of positions of the vehicle terminal and (i-b) a plurality of pieces of specific vehicle position information each being the vehicle position information and indicating one of the plurality of positions of the vehicle terminal, and (ii) transmitting the plurality of pieces of signal identification information and the plurality of pieces of specific vehicle position information to the passenger terminal; and
after transmitting the plurality of pieces of signal identification information and the plurality of pieces of specific vehicle position information to the passenger terminal, receiving, from the passenger terminal, corrected passenger position information indicating a corrected position of the passenger terminal, and transmitting the corrected passenger position information to the vehicle terminal.

15. The information processing method according to claim 14, further comprising:
after the signal transmitted at each of the plurality of positions of the vehicle terminal is received, receiving, from the passenger terminal, the plurality of pieces of signal identification information and a request for the plurality of pieces of specific vehicle position information, and transmitting the plurality of pieces of specific vehicle position information to the passenger terminal as a response to the request.

16. The information processing method according to claim 14, further comprising:
generating navigation information for the vehicle terminal or the passenger terminal using the vehicle position information and the corrected passenger position information, and transmitting the navigation information to the vehicle terminal or the passenger terminal.

17. The information processing method according to claim 16, further comprising:
when the passenger position information is not obtained, generating the navigation information including information that guides the passenger to enable the passenger position information to be obtained.

18. The information processing method according to claim 14, further comprising:
instructing the vehicle terminal to start transmitting the signal when the vehicle terminal and the passenger terminal are in a predetermined positional relationship.
